(19) United States
(12) Patent Application Publication
(10) Pub. No.: US 2025/0198951 A1
(43) Pub. Date: Jun. 19, 2025

(54) Collimator for an X-ray inspection system, X-ray laminography system with such a collimator, and use of such a collimator

(71) Applicant: Comet Yxlon GmbH, Hamburg (DE)

(72) Inventors: André Schu, Hamburg (DE); Björn Schrader, Hamburg (DE); Andreas Deresch, Hamburg (DE)

(21) Appl. No.: 18/980,600

(22) Filed: Dec. 13, 2024

(30) Foreign Application Priority Data
Dec. 18, 2023 (DE) 10 2023 135 434.5

(51) Int. Cl. G01N 23/044; G01N 23/083

(52) U.S. Cl. CPC G01N 23/044; G01N 23/083; G01N 2223/316; G01N 2223/6116

(57) ABSTRACT

The present disclosure relates to a collimator for an X-ray inspection system that is plate-shaped with a bottom side and a top side that is made of a material that is a good absorber of X-rays, with a collimator aperture, the collimator aperture having an inlet surface on the bottom side that has a first center of area and an outlet surface on the top side that has a second center of area. According to the present disclosure, either the collimator aperture, when installed in an X-ray laminography system, is not struck by a central beam of a cone beam emitted by an X-ray tube of this X-ray laminography system, or the first center of area and the second center of area form a collimation axis that forms a collimation angle with the normal of the surface of the collimator 1γ not equal to zero.

### PRIORITY CLAIM

The present application claims priority under 35 U.S.C. § 119 to German Patent Application No. DE 10 2023 135 434.5, filed Dec. 18, 2023, the disclosure of which is incorporated by reference herein in its entirety.

### TECHNICAL FIELD

The present disclosure relates to a plate-shaped collimator for an X-ray inspection system made of a material that is a good absorber of X-rays and has a collimator aperture. Furthermore, the disclosed embodiments relate to an X-ray laminography system with such a collimator by means of which a useful beam is generated from a cone beam generated in a focus of an X-ray tube. Furthermore, some embodiments relate to the use of such a collimator in an X-ray laminography system.

### DESCRIPTION OF STATE OF THE ART

X-ray laminography scans are typically used to inspect flat, extensive test objects such as circuit boards or wafers. Since circuit boards usually contain various assemblies with different components, various inspection positions on the circuit boards are usually approached, and a plurality of scans are carried out one after the other. X-ray laminography systems often have transmission X-ray tubes, as this type of tube allows the test object to be brought as close to the focus as possible, thus enabling high magnifications to be achieved. In transmission X-ray tubes, the target that generates the radiation usually forms the end of the X-ray tube. This type of X-ray tube produces cone beams with a large aperture angle, for example 170°, with a large portion of the cone beam usually striking the circuit board. The combination of many inspection positions, very small distances to the focus, and large aperture angles of the cone beam striking the board results in a high radiation exposure for the components to be inspected on the board. This can also expose areas of the circuit board to high levels of radiation that are not visible in the X-ray image during the entire inspection procedure. Depending on the component arranged in such an area, this can lead to radiation damage to the component, particularly in the areas located in the direction of the central beam of the cone beam.

### SUMMARY

It is the object of the present disclosure to provide a way to significantly reduce the radiation exposure for components during an X-ray inspection that occurs during the inspection of other components, in particular during a laminography scan.

Such solutions are known from the prior art in the form of filters that reduce the overall exposure level. However, such filters reduce the potency of the entire cone beam, including the portion that is needed in order to examine the subregion of the circuit board that is of interest. A filter can be used to disproportionately filter out the low-energy parts of the spectrum. This reduces the dose to which the test object is exposed, since the low-energy radiation components mostly only result in an exposure dose for the test object but hardly add any value to the image quality. However, filtering always also results in parts of the spectrum being filtered out that are beneficial to image quality. Filtering therefore always requires the integration time or power to be increased in order to achieve the same image quality as without filtering.

The object is achieved according to the present disclosure by a collimator having the features of claim 1 or 2, a laminography X-ray device with such a collimator having the features of claim 10, and a use of such a collimator in an X-ray laminography system according to the features of claim 13. Advantageous embodiments are specified in the subclaims.

According to the disclosed embodiments, the object is achieved by a collimator that is plate-shaped with a bottom and a top and is made of a material that is a good absorber of X-rays. The collimator has a collimator aperture that has an inlet surface on the bottom side having a first center of area and an outlet surface on the top side having a second center of area. There are two possible embodiments available to achieve the object. In the first embodiment, the collimator aperture, when installed in an X-ray laminography system, is not struck by a central beam of a cone beam emitted by an X-ray tube of this X-ray laminography system. In the second embodiment, the first center of area and the second center of area form a collimation axis that forms a collimation angle with the normal of the surface of the collimator that is not equal to zero. In both designs, only a small portion of the total X-ray beam emitted onto the collimator from the focus of the X-ray tube is transmitted, and all components of a test object that are not in alignment with the focus and collimator aperture—the inspection area—are not exposed to X-rays, so that they cannot be damaged due to a high dose of X-ray radiation. The collimator aperture provides an X-ray beam with a very limited useful beam aperture angle behind the collimator, which only strikes the inspection area of the test object during the scan.

One advantageous refinement of the disclosed embodiments makes a provision that the inlet surface and the outlet surface are each a circle, an ellipse, a trapezoid, a square, a pentagon, or a hexagon. In the preferred variant of two symmetrical trapezoids as inlet and outlet surfaces, a truncated pyramid-shaped volume of the collimator aperture can be achieved if these surfaces are chosen in a geometrically correct manner, which results in a rectangular beam as the useful beam behind the collimator that is able to illuminate a rectangular detector in the best possible manner. In the variant with two ellipses as inlet and outlet surfaces, a frustoconical volume of the collimator aperture can be obtained if these surfaces are chosen in a geometrically correct manner, which results in a conical beam as the useful beam behind the collimator; this is preferred if a circular detector is present. The other variants represent collimator apertures that are easy to manufacture and that also result in good, albeit not as efficient, useful beams.

Another advantageous refinement of the disclosed embodiments makes a provision that the collimator aperture does not encompass the center of area of the bottom side of the collimator and the second center of area of the outlet surface is located farther out than the first center of area of the inlet surface on the collimator. This makes it possible to create a collimator having mass in its central region, so that the central beam of the X-ray tube is absorbed and does not strike the test object, and the collimation axis extends outward in the collimator with a directional component in the beam direction, whereby the central beam can strike the collimator in the middle when the collimator is installed and the collimation axis of the collimator aperture extends along the useful beam, which is at an angle to the central beam that is not equal to zero, so that the useful beam is incident upon the inspection area arranged in alignment with the focus and the collimator aperture, so that it is not unnecessarily partially absorbed at the edges of the collimator aperture, which would lead to interference effects.

Another advantageous refinement of the present disclosure makes a provision that the inlet surface of the collimator aperture and the outlet surface of the collimator aperture each extend to the edge of the collimator. Such a shape is easy to manufacture, because the collimator aperture coincides with the edge of the collimator on one side.

The collimator preferably has a thickness of from 0.1-5.0 mm.

Another advantageous refinement of the present disclosure makes a provision that the aperture angle of the collimator aperture is between 1° and 40°. This creates a partial beam from the entire X-ray beam generated in the focus that is sufficient to illuminate an inspection area of a test object to be inspected. The other, uninspected areas of the test object are not exposed to an unnecessary radiation dose.

Another advantageous refinement of the present disclosure makes a provision that the collimation angle is between 10° and 70°, preferably between 40° and 60°. This enables the inspection area to be inspected at an angle when performing an X-ray laminography procedure that allows for very good detection of possible defects in components and better separation of the different levels in the inspection area.

Another advantageous refinement of the present disclosure makes a provision that it is made of a material with a high average atomic number and high density, in particular of tungsten or a tungsten alloy, the material preferably having the greatest possible dimensional stability. This provides good shielding of all areas of the test object that are not to be inspected and also enables the collimator to be made thin.

Another advantageous refinement of the present disclosure makes a provision that the collimator has more than one collimator aperture. This enables multiple inspection areas of the test object that lie outside the central beam of the X-ray tube to be inspected simultaneously.

Furthermore, the object is also achieved by an X-ray laminography system according to the disclosed embodiments. It includes an X-ray tube, in particular a transmission X-ray tube, which has a focus at which X-rays are generated in the form of a cone beam. It also has a detector that is struck by a useful beam of the cone beam. A collimator according to the present disclosure is arranged between the focus and the detector. The collimator aperture of the collimator is aligned in such a way that only that portion of the X-ray radiation of the cone beam generated at the focus that forms the useful beam is allowed to pass through it, so that a test object to be inspected that can be placed between the collimator and the detector in the X-ray beam is only exposed to the X-ray radiation in one inspection area. This achieves the advantages already listed above regarding the collimator and the use thereof.

One advantageous refinement of the X-ray laminography system according to the present disclosure makes a provision that the detector is fully illuminated. As already described above, this does not restrict the field of vision. With precise illumination—i.e., the entire useful beam illuminates exactly the active surface of the detector—an optimal ratio is obtained between the dose introduced into the inspection area and low information loss in the detector. Preferably, the entire X-ray radiation of the useful beam strikes the detector. Since this is practically impossible to achieve, the design is such that as little of the useful beam as possible does not strike the detector.

Another advantageous refinement of the X-ray laminography system according to the present disclosure makes a provision that the normal of the surface of the collimator is parallel to the central beam of the cone beam. This makes a very simple arrangement of the collimator in the X-ray laminography system possible.

Finally, the object is also achieved through the use of a collimator according to the present disclosure in an X-ray laminography system, since this results in the strong reduction of the dose described above for all areas of the test object that are not the inspection area. In laminography applications, the detector is usually positioned at as large an angle as possible to the central beam emitted by the focus. The disclosed embodiments reduce the useful beam by a collimator to the angular range in which the detector is located. This reduces the exposure dose for all components that are not in the useful beam. This can be used to achieve an especially large reduction of the exposure dose for components that are located directly above the focus during a laminography scan. Due to their position, these components would be even more strongly irradiated in an application without the collimator according to the disclosed embodiments than the components that are in the image during the scan. Particularly when testing sensitive test pieces, the disclosed embodiments reduces damage to components such as semiconductor components, in particular wafers or semiconductor memories.

One advantageous refinement of the use according to the present disclosure makes a provision that the collimator is arranged between a focus of an X-ray tube and a test object to be inspected together with a detector located behind it in the beam direction, such that the portion of a cone beam emitted by the X-ray tube that is allowed through the collimator aperture penetrates the test object in a subregion to be inspected and, in particular, fully illuminates the detector. By virtue of the full illumination of the detector, the field of view is not restricted and there is no loss of information.

### BRIEF DESCRIPTION OF THE DRAWINGS

Further details and advantages of the disclosed embodiments will now be explained in greater detail with reference to exemplary embodiments illustrated in the drawings, in which:

FIG. 1 shows a schematic representation of a known X-ray laminography system.

FIG. 2 shows a schematic representation of a X-ray laminography system according to some embodiments.

FIG. 3 shows a first exemplary embodiment of a collimator according to some embodiments in a plan view and in cross section.

FIG. 4 shows a second exemplary embodiment of a collimator according to some embodiments in plan view and in cross section.

FIG. 5 shows a third exemplary embodiment of a collimator according to some embodiments in plan view and in cross section.

FIG. 6 shows a fourth exemplary embodiment of a collimator according to some embodiments in plan view and in cross section.

### DETAILED DESCRIPTION

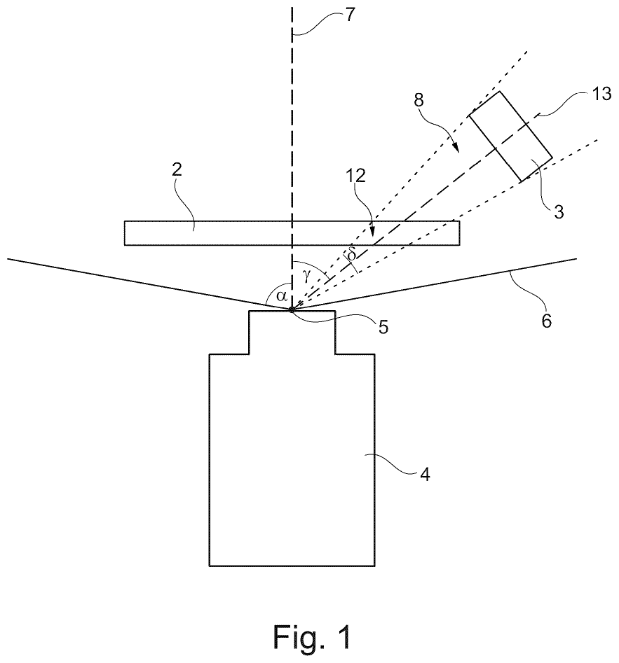

FIG. 1 shows a schematic example of the structure of an X-ray laminography system that is known from the prior art. It has an X-ray tube 4—here: a transmission X-ray tube—which in its focus 5 produces a cone beam 6 with a half aperture angle α of approximately 85°. A test object 2 in the form of a circuit board is located in the cone beam 6. The central beam 7 of the cone beam 6 is substantially perpendicular to the surface of the test object 2. Not the entire test object 2 is to be inspected, but only a subregion—referred to as the inspection area 12. The inspection area 12 is not in the direction of the central beam 7, but at an observation angle γ tilted toward the same. In the example shown, the observation angle γ is approximately 60°. In X-ray laminography, the separation of layers within the test object 2 is better the larger the observation angle γ is. The inspection area 12 is located between the focus 5 and a detector 3. The rays of the cone beam 6, which emanate from the focus 5 and strike the detector 3 at the outermost point, form a field of view 8 that is formed around the observation axis 13, which is at the observation angle γ to the central beam 7 and strikes the detector 3 in the middle. The field of view 8 has a field of view aperture angle δ of approximately 20°. The inspection area 12 must be in the field of view 8 during the inspection of the inspection area—i.e., during the execution of the laminography scan. In the example shown, large portions of the test object 2 are located in the cone beam 6 and are exposed to the dose but are not in the field of view 8. Therefore, the exposure dose has no benefit in large portions of the test object 2. If there are X-ray-sensitive components on the test object 2, such a high exposure dose can lead to damage. The implementation of the laminography scan is known from the prior art and is not the subject of the present disclosure, so it will not be discussed further.

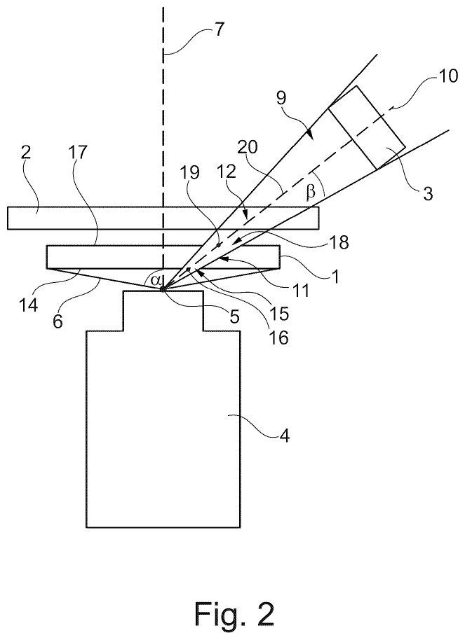

The disclosed embodiments prevent such damage due to high levels of exposure. FIG. 2 shows a schematic example of an inventive construction of an X-ray inspection system. The structure of the X-ray laminography system according to the disclosed embodiments as per FIG. 2 is identical except for a collimator 1 according to the disclosed embodiments arranged between the focus 5 and the test object 2, so that same features are provided with same reference numerals and will not be explained again below. Instead, only the differences will be discussed in any greater detail.

The collimator 1 is plate-shaped and thus has a very small thickness compared to its extent in a plane. It has a bottom side 14 facing the X-ray tube 4 and a top side 17 facing away from the X-ray tube 4. In order to shield the X-ray radiation of the cone beam 6 as well as possible in all areas except the inspection area 12, it is made of a material that has a high atomic number; if the collimator 1 is made of an alloy or different materials, it should have a high average atomic number. A high (average) atomic number is considered to be a value above 26. Furthermore, the collimator 1 is made of a high-density material, preferably of greater than 7,500 kg/m³, for example. In order to ensure simple manufacturing and low susceptibility to mechanical deformation, a material that is as dimensionally stable as possible is used. In this case, it is a tungsten alloy, namely Densimet®.

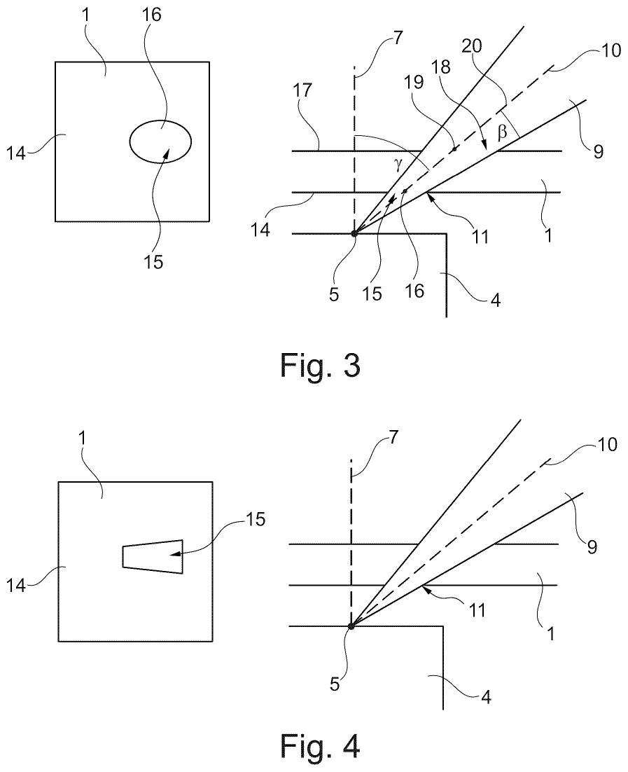

The collimator 1 has a collimator aperture 11, as can be clearly seen in FIG. 2 as well as in the two exemplary embodiments of FIGS. 3 and 4.

In the first exemplary embodiment according to FIG. 3, the collimator aperture 11 is frustoconical in shape around a central axis. For this purpose, an inlet surface 15 is provided on the bottom side 14 of the collimator 1 that is elliptical and has a first surface center of area 16. On the top side 17 of the collimator 1 there is an outlet surface 18 that is also elliptical and has a second surface center of area 19. The inlet surface 15 and the outlet surface 18 are coordinated with one another in terms of their geometric features such that the volume of the collimator aperture 11 forms a truncated cone (the specific design is easy to determine for those skilled in the art). The collimation axis 20 defined by the first center of area 16, and the second center of area 19 corresponds to the central beam 10. This produces a conical useful beam 9 behind the collimator 1 that is symmetrical about a central beam 10 and illuminates the detector 3. Optimal illumination can be achieved if the detector 3 is circular.

The central beam 10 corresponds to the observation axis 13 described above in FIG. 1 and the aperture angle—shown in FIG. 3 is half the useful beam aperture angle β—is approximately equal to the field of view aperture angle δ from FIG. 1. The collimation angle γ depends on the position of the detector 3—it is therefore larger the farther the observation axis 13 is from the central beam 7. The size of the field of view aperture angle δ depends—if an ideal constellation is desired—on the size of the detector 3 and the distances of the collimator 1 from the focus 5 and of the collimator 1 from the detector 3. This means that scans at different laminography angles require different collimators 1, that must be exchanged before performing the laminography scan. For optimal results, different collimators 1 would also have to be used at different distances between collimator 1 and focus 5 and between collimator 1 and detector 3. The collimator aperture 11 is formed outside the center of the collimator 1; as a result, the collimator 1 can be arranged centrally above the central beam 7 and shields the X-rays not emitted in the area of the useful beam 9 in all directions of the cone beam 6 and thus protects the uninspected areas of the test object 2. This minimizes the exposure dose of the portion of the test object 2 that is not in the field of view 8 and thus in the useful beam 9. Through the use of a collimator 1 according to the disclosed embodiments, radiation-sensitive components of the test object 2 are thus subjected to substantially less stress when they are not in the field of view 8. This also makes it possible to approach multiple inspection positions on test object 2 without irradiating the entire test object 2 and impacting all components. This is particularly advantageous for a circuit board with X-ray sensitive components.

The second embodiment of FIG. 4 differs from the first embodiment of FIG. 3 only in the shape of the inlet surface 15 and of the outlet surface 18. Instead of being elliptical, they each have the shape of a symmetrical trapezoid. The representation of the centers of area 16, 19 of the inlet surface 15 and the outlet surface 18 as well as of the collimation axis 20 defined thereby has been omitted, since this does not present any difficulty to those skilled in the art starting from FIG. 3. Thus, the volume of the collimator aperture 11 now has a truncated pyramid shape instead of a truncated cone shape according to FIG. 3, which results in a rectangular beam as the useful beam 9. This is especially good when using a rectangular detector 3—which is the usual case—since it can be optimally illuminated completely by the useful beam, enabling the greatest possible efficiency to be achieved.

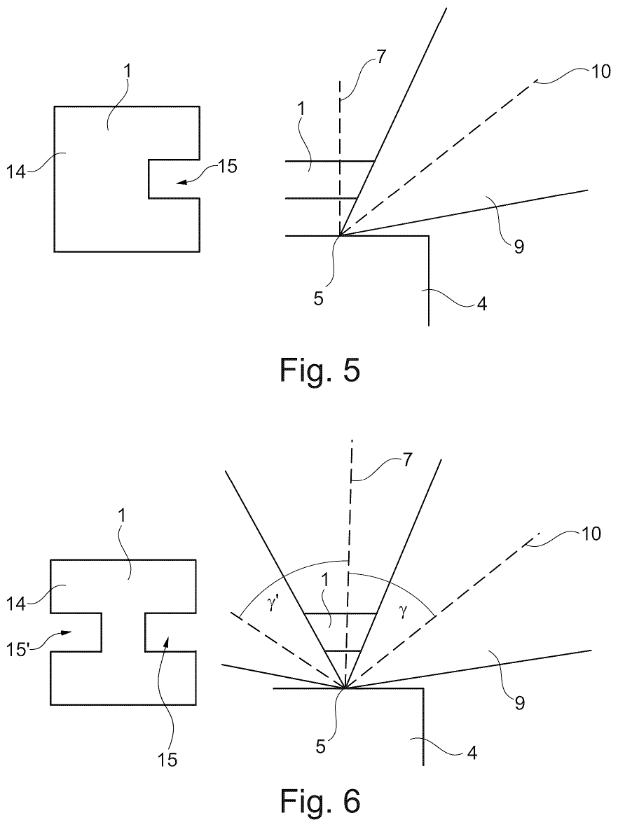

FIG. 5 shows a third embodiment, which has a rectangular inlet surface 15 but which—unlike the two preceding exemplary embodiments—extends to the edge of the collimator 1, so that one of its sides coincides with the edge of the collimator 1. Although this increases the exposure dose of the component in the outer region, the collimator aperture 11 is easier to manufacture. The coordination of the outlet surface 18 with the inlet surface 15 is easy for those skilled in the art to determine on the basis of the geometric conditions.

FIG. 6 shows a fourth embodiment, which differs from the third embodiment of FIG. 5 only in that, in addition to the collimator aperture on the right side (represented by the inlet surface 15), there is a further collimator aperture on the left side (represented by the inlet surface 15′). This enables two different inspection areas 12 in the test object 2 to be inspected simultaneously. The left inlet surface 15′ has different dimensions than the right inlet surface 15, as can be clearly seen from the cross-sectional view on the right, so that different collimation angles (right γ and left γ′)—the right collimation angle γ being smaller than the left collimation angle γ′ in the exemplary embodiment. This is only an example, and the actual design to be selected depends on the requirements of the respective application, particularly on where the inspection areas 12 are located in the test object 2.

Instead of providing two collimator apertures 11 as shown in FIG. 6, even more collimator apertures 11 could be provided, or the collimator apertures 11 could be formed at other locations in the collimator 1. It should be noted, however, that with each of these collimator apertures 11 according to FIGS. 5 and 6, the exposure dose in the outer region is increased.

### LIST OF REFERENCE SYMBOLS

1 collimator
2 test object
3 detector
4 X-ray tube
5 focus
6 cone beam
7 central beam
8 field of view
9 useful beam
10 central beam
11 collimator aperture
12 inspection area
13 observation axis
14 bottom side
15, 15′ inlet surface
16 first center of area
17 top side
18 outlet surface
19 second center of area
20 collimation axis
α half aperture angle
β half the useful beam aperture angle
γ, γ′ collimation angle
δ field of view aperture angle

1. A collimator for an X-ray inspection system, wherein the collimator is plate-shaped with a bottom and a top that is made of a material that is a good absorber of X-rays, wherein the collimator includes:
a collimator aperture, wherein the collimator aperture has an inlet surface on the bottom that has a first center of area and an outlet surface on the top that has a second center of area, wherein the collimator aperture, when installed in an X-ray laminography system, is not struck by a central beam of a cone beam emitted by an X-ray tube of the X-ray laminography system.

2. The collimator according to claim 1, wherein the inlet surface and the outlet surface are each one of a circle, an ellipse, a quadrilateral, a pentagon, or a hexagon.

3. The collimator according to claim 1, wherein a volume of the collimator aperture is a truncated cone or a truncated pyramid whose respective central axis is a collimation axis.

4. The collimator according to claim 1, wherein the collimator aperture does not comprise a center of area of the bottom of the collimator, and the second center of area of the outlet surface is located farther out than the first center of area of the inlet surface on the collimator.

5. The collimator according to claim 1, wherein the inlet surface of the collimator aperture and the outlet surface of the collimator aperture each extend to an edge of the collimator.

6. The collimator according to claim 1, wherein the collimator has a thickness of 0.1-5.0 mm and/or an aperture angle of the collimator aperture is between 1° and 40° and/or a collimation angle (γ) is between 10° and 70°.

7. The collimator according to claim 1, wherein the collimator is made of a material with a high average atomic number and a high density.

8. The collimator according to claim 1, wherein the collimator includes at least one additional collimator aperture.

9. A use of the collimator according to claim 1 in the X-ray laminography system for reducing an exposure dose for a test object to be inspected.

10. The use according to claim 9, wherein the collimator is arranged between a focus of an X-ray tube and the test object to be inspected together with a detector located behind the test object in a beam direction, such that a portion of a cone beam emitted by the X-ray tube that is allowed through the collimator aperture penetrates the test object in an inspection area to be inspected and fully illuminates the detector.

11. A collimator for an X-ray inspection system, wherein the collimator is plate-shaped with a bottom and a top that is made of a material that is a good absorber of X-rays, wherein the collimator includes:
a collimator aperture, wherein the collimator aperture has an inlet surface on the bottom that has a first center of area and an outlet surface on the top that has a second center of area, wherein the first center of area and the second center of area form a collimation axis that forms a collimation angle (γ) not equal to zero.

12. The collimator according to claim 11, wherein the inlet surface and the outlet surface are each one of a circle, an ellipse, a quadrilateral, a pentagon, or a hexagon.

13. The collimator according to claim 11, wherein a volume of the collimator aperture is a truncated cone or a truncated pyramid whose respective central axis is the collimation axis.

14. The collimator according to claim 11, wherein the collimator aperture does not comprise a center of area of the bottom of the collimator, and the second center of area of the outlet surface is located farther out than the first center of area of the inlet surface on the collimator.

15. The collimator according to claim 11, wherein the inlet surface of the collimator aperture and the outlet surface of the collimator aperture each extend to an edge of the collimator.

16. The collimator according to claim 11, wherein the collimator has a thickness of 0.1-5.0 mm and/or an aperture angle of the collimator aperture is between 1° and 40° and/or the collimation angle (γ) is between 10° and 70°.

17. The collimator according to claim 11, wherein the collimator includes at least one additional collimator aperture.

18. An X-ray laminography system with an X-ray tube, wherein the X-ray tube has a focus at which X-rays are generated in a form of a cone beam, with a detector that is struck by a useful beam of the cone beam, and with a collimator arranged between the focus and the detector, wherein a collimator aperture of the collimator is aligned such that only that portion of the X-rays of the cone beam generated at the focus that forms the useful beam is allowed to pass through the collimator aperture, so that a test object to be inspected that can be introduced into the cone beam between the collimator and the detector is only exposed to the X-rays in an inspection area.

19. The X-ray laminography system according to claim 18, wherein the detector is fully illuminated but as little X-ray radiation of the useful beam as possible does not strike the detector.

20. The X-ray laminography system according to claim 18, wherein a normal of a surface of the collimator is parallel to a central beam of the cone beam.
